(19) United States
(12) Patent Application Publication
(10) Pub. No.: US 2015/0331220 A1
(43) Pub. Date: Nov. 19, 2015

(54) Lens Driving Device

(71) Applicant: Nidec Copal Corporation, Tokyo (JP)

(72) Inventors: Kazuo SHIKAMA, Tokyo (JP); Hiroyuki WATANABE, Tokyo (JP)

(73) Assignee: NIDEC COPAL CORPORATION, Tokyo (JP)

(21) Appl. No.: 14/609,002

(22) Filed: Jan. 29, 2015

(30) Foreign Application Priority Data
Feb. 1, 2014 (JP) 2014-018120

(51) Int. Cl. G02B 7/04

(52) U.S. Cl. CPC G02B 7/04

(57) ABSTRACT

A lens driving device includes: a lens frame, a base member, and a supporting portion that supports the lens frame so as to be able to move, relative to the base member, in the direction of the optical axis and in the direction that is perpendicular to the optical axis. The lens driving device also includes a driving unit that drives respectively the lens frame in the direction of the optical axis and in the direction perpendicular to the optical axis. The supporting portion includes a path for supplying power to the driving unit. The base member includes a plurality of connecting terminals wherein the external connecting faces thereof are exposed. The paths for supplying power to the driving unit are connected to the connecting terminals.

### CROSS REFERENCE TO RELATED APPLICATION

This application claims priority under 35 U.S.C. §119 to Japanese Patent Application No. 2014-018120, filed on Feb. 1, 2014, the entire content of which being hereby incorporated herein by reference.

### FIELD OF TECHNOLOGY

The present invention relates to a lens driving device.

### SUMMARY

There are known lens driving devices that, in addition to functions for adjusting the focus by both driving the lens frame in the direction of the optical axis and driving the lens frame in a plane that is perpendicular to the optical axis, have a function for correcting deflection. See, for example, Japanese Unexamined Patent Application Publication No. 2013-156292. This type of lens driving device includes a base member, a movable member, disposed on the base member, and able to move to handle image deflection within a plane that is perpendicular to the optical axis, a lens frame, attached to the movable member, that can move in the direction of the optical axis, and a flexible substrate for supplying an electric current to a coil, connected electrically to a coil that is provided on the movable member or the lens frame.

In a lens driving device that has a deflection correcting function and a focus adjusting function, electric currents are supplied in response to respective control signals for a coil for driving the deflection correction and a coil for driving the focus adjustment. Because of this, in such a lens driving device separate individual power supply paths are provided for the coil for driving the deflection correction and the coil for driving the focus adjustment through flexible substrates, interconnections, or the like. The conventional lens driving device has a problem in that the work of assembly into camera modules and into various types of electronic instruments is complex due to having to connect the individual terminals for the individual power supply paths one-at-a-time to the power supplies.

Moreover, when the power supply paths of flexible substrates, or the like, are disposed around the lens frame, a relatively large amount of interconnection space is required around the lens frame, so there is a problem in that the space occupied by installing the lens driving device is larger. In mobile electronic instruments wherein there is the need for miniaturization, there is the need to make the space required for the installation of the built-in lens driving device as small as possible.

In the present invention, the handling of such problems is one example of the problem to be solved. That is, aspects of the present invention are to enable a simplification in connecting the lens driving device to the power supplies, and to enable a reduction in the space occupied through the installation of the lens driving device.

### SUMMARY

In order to achieve such aspects, the present invention provides a lens driving device including, for example, a lens frame, a base member, and a supporting portion that supports the lens frame so as to be able to move, relative to the base member, in the direction of the optical axis and in the direction that is perpendicular to the optical axis. The lens driving device also includes a driving unit that drives respectively the lens frame in the direction of the optical axis and in the direction perpendicular to the optical axis. The supporting portion includes a path for supplying power to the driving unit. The base member includes a plurality of connecting terminals wherein the external connecting faces thereof are exposed. The paths for supplying power to the driving unit are connected to the connecting terminals.

### BRIEF DESCRIPTIONS OF THE DRAWINGS

FIG. 1 is an explanatory diagram (an assembly perspective diagram) illustrating the structure of critical portions of a lens driving device according to an example according to the present invention.

FIG. 2 is explanatory diagrams illustrating structures of critical portions of a lens driving device according to an example according to the present invention (wherein (a) is a perspective diagram of the critical portions and (b) is a front view of the critical portions).

FIG. 3 is explanatory diagrams illustrating structures of critical portions of a lens driving device according to an example according to the present invention (wherein (a) is a cross-sectional diagram of the critical portions and (b) is a back view of the critical portions).

FIG. 4 is explanatory diagrams illustrating details of the base member for the driving device according to an example according to the present invention (wherein (a) is a plan view diagram and (b) is a cross-sectional diagram along the section A-A).

FIG. 5 is an explanatory diagram illustrating an example of an electronic instrument, or the like, provided with a lens driving device according to an example according to the present invention.

### DETAILED DESCRIPTION

The lens driving device according to an example according to the present invention includes: a lens frame; a base member; and a supporting member for supporting the lens frame so as to be able to move, relative to the base member, in the direction of the optical axis and in direction that are perpendicular to the optical axis. Moreover, driving means are provided for driving the lens frame in the direction of the optical axis and in the directions are is perpendicular to the optical axis. Moreover, supporting portion is provided with a power supply path to the driving means, the base member is provided with a plurality of connecting terminals, with exposed external connecting faces, and the power supply paths to the driving means are connected to the connecting terminals. In such a lens driving device, power can be supplied to the driving means through connecting the external connecting faces of the plurality of connecting terminals, provided on the base member, to the power supplies, enabling the plurality of paths for supplying power to the driving means to be connected to the power supplies all at once. This can simplify the work of connecting the lens driving device to the power supplies, enabling simplification of the work of assembling the lens driving device to the camera module.

Moreover, because supporting portions, for supporting the lens frame, relative to the base member, so as to enable movement in the direction of the optical axis and in the direction perpendicular to the optical axis, are provided with paths for supplying power to the driving means, there is no need to provide power supply paths such as separate flexible substrates, and the like, around the lens frame. Moreover, this enables power to be supplied to the driving means through the supporting portions within the area wherein the base member is installed. This enables a reduction in the space in the area occupied through the installation of the lens driving device.

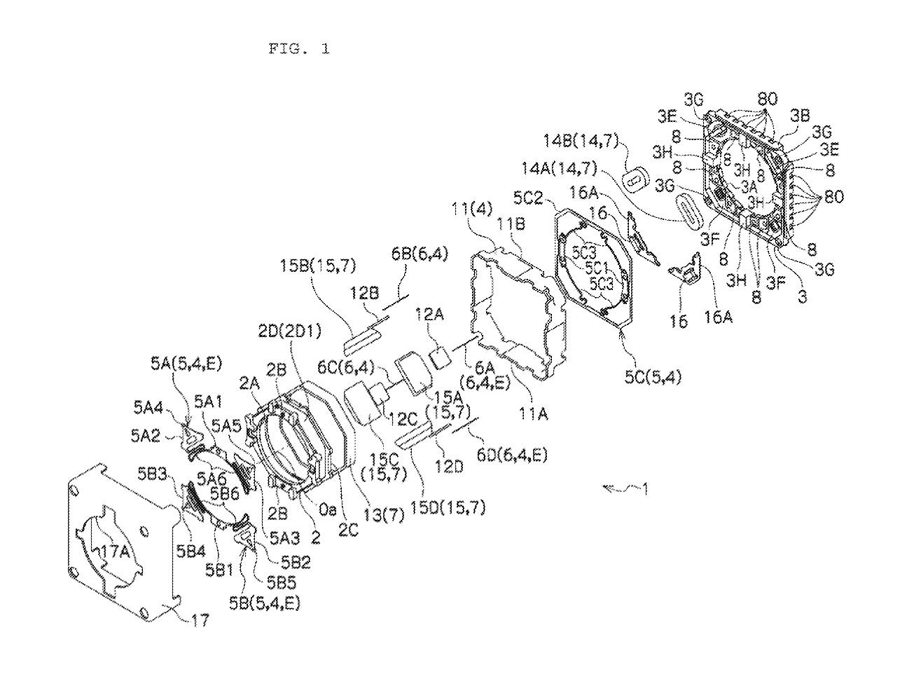

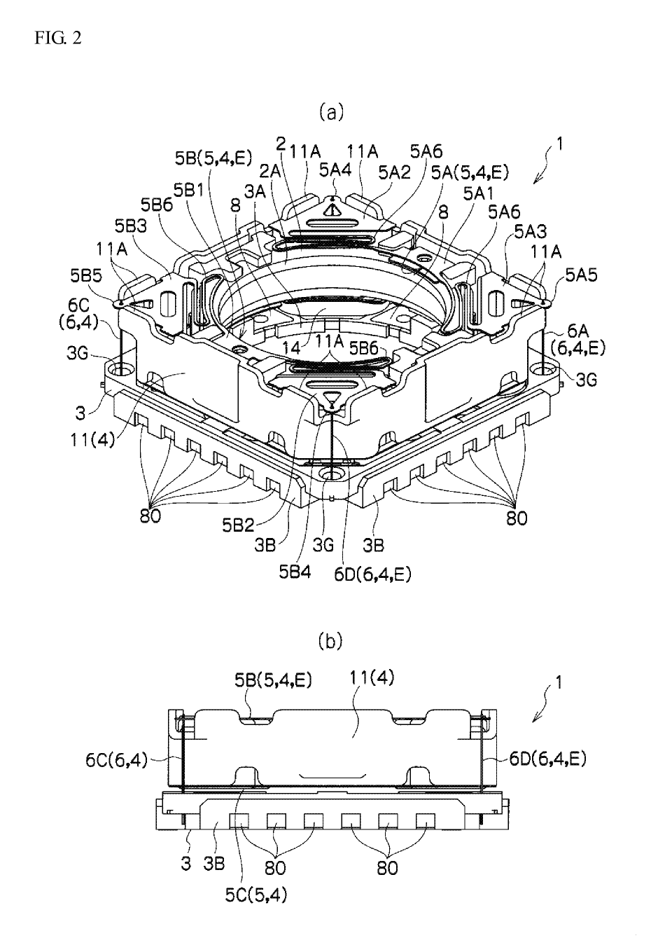

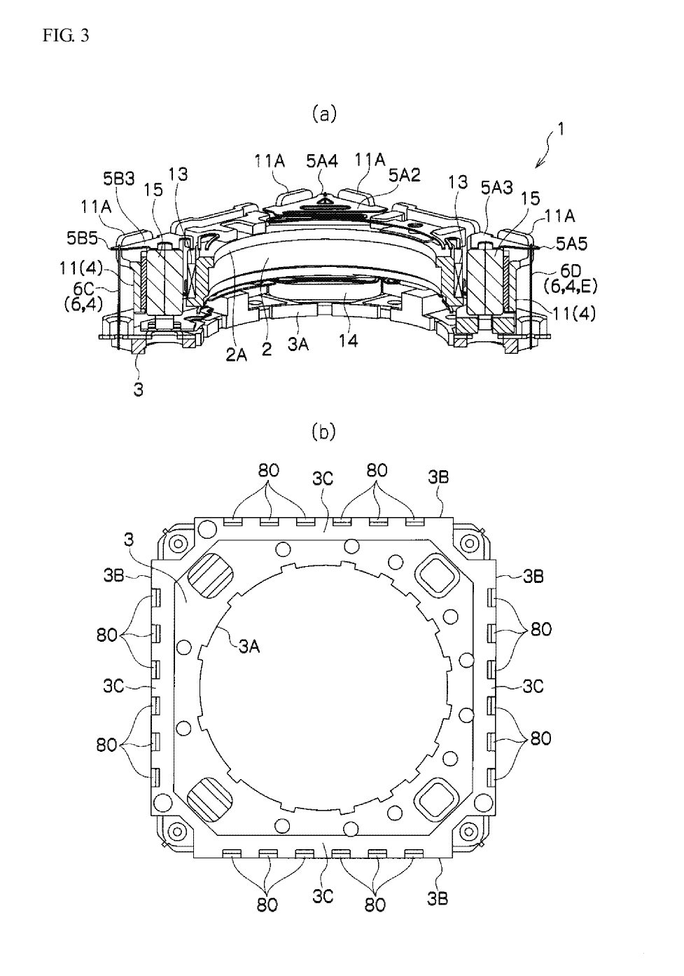

Examples of the present invention will be described below in reference to the drawings. In the drawings below, identical codes are assigned to identical parts, and a portion of explanations that are redundant for the individual drawings will be omitted. FIG. 1 through FIG. 3 are explanatory diagrams illustrating structures of critical portions of a lens driving device according to an example according to the present invention, wherein FIG. 1 is an assembly perspective diagram, FIG. 2 (a) is a perspective diagram of critical portions, FIG. 2 (b) is a front view diagram of critical portions, FIG. 3 (a) is a cross-sectional diagram of critical portions, and FIG. 3 (b) is a back view diagram of critical portions.

The lens driving device 1 includes: a lens frame 2, a base member 3, a supporting portion 4, and driving means 7. The lens frame 2 includes a lens attaching opening 2A to which a lens barrel, not shown, is attached, where a top end attaching portion 2B is attached to one end side along an optical axis Oa and that is positioned at the center of the lens attaching opening 2A, and a bottom end attaching portion 2C is provided on the other end side. Moreover, a coil holding portion 2D1 is provided on a side face 2D of the lens frame 2. The lens frame 2 is supported on a base member 3 through a supporting portion 4.

In the example in the drawing, the supporting portion 4 is structured from an annular yoke 11, a first elastic supporting member 5, and a second elastic supporting member 6. The annular yoke 11 is a magnetic material that surrounds around the frame lens 2, and, in the example that is illustrated, is structured from a rectangular frame member, where magnets 15 (15A, 15B, 15C, and 15D), which are structural elements of the driving means 7, are attached to the four corners thereof.

The first elastic supporting member 5 supports the lens frame 2 elastically, along the direction of the optical axis, relative to the annular yoke 11, and, in the example that is illustrated, is structured from top leaf springs 5A and 5B that are attached between the top end attaching portion 2B of the lens frame 2 and the top edge 11A of the annular yoke 11, and a bottom leaf spring 5C that is attached between the bottom end attaching portion 2C of the lens frame 2 and the bottom edge 11B of the annular yoke 11.

The top leaf springs 5A and 5B are disposed in a state wherein a pair of members on the left and the right are mutually insulated from each other, where the top leaf spring 5A includes a lens frame attaching portion 5A1, annular yoke attaching portions 5A2 and 5A3, wire support attaching portions 5A4 and 5A5, and an elastic deforming portion 5A6, where the top leaf spring 5B includes a lens frame attaching portion 5B1, annular yoke attaching portions 5B2 and 5B3, wire support attaching portions 5B4 and 5B5, and an elastic deforming portion 5B6. The lens frame attaching portions 5A1 and 5B1 of the top leaf springs 5A and 5B are attached to the top end attaching portion 2B of the lens frame 2, and the annular yoke attaching portions 5A2, 5A3, 5B2, and 5B3 of the top leaf springs 5A and 5B are attached to the top edge 11A of the annular yoke 11. Moreover, the bottom leaf spring 5C is provided with a pair of lens frame attaching portions 5C1 and 5C1, an annular yoke attaching portion 5C2 that is of an annular shape, and an elastic deforming portion 5C3, wherein the lens frame attaching portions 5C1 and 5C1 are attached to the bottom end attaching portion 2C of the lens frame 2, and the annular yoke attaching portions 5 C2 is attached to the bottom edge 11B of the annular yoke 11.

The second elastic supporting member 6 supports the annular yoke 11, relative to the base member 3, elastically along the direction that is perpendicular to the optical axis, and, in the example that is illustrated, is structured from a plurality of wire supports 6A, 6B, 6C, and 6D. The plurality of wire supports 6A, 6B, 6C, and 6D have the top end portions thereof attached to the wire support attaching portions 5A4, 5A5, 5B4, and 5B5 of the top leaf springs 5A and 5B that are attached to the annular yoke 11, with the bottom end portions thereof attached within insertion holes 3G that are equipped in the four corners of the base member 3. These wire supports 6A, 6B, 6C, and 6D support the lens frame 2, the annular yoke 11, and the first elastic supporting member 5 over the base member 3 in a suspended state, enabling the lens frame 2 or the annular yoke 11 to move in a direction that is perpendicular to the optical axis Oa through elastic deformation of the wire supports 6A, 6B, 6C, and 6D.

The driving means 7 structure an electromagnetic actuator through a first coil 13, second coils 14 (14A and 14B), and magnets 15 (15A, 15B, 15C, and 15D). The electromagnetic actuator is an example of the driving unit. The first coil 13 is wound onto a coil holding portion 2D1 at a side face 2D of the lens frame 2, to structure, in cooperation with the magnets 15 (15A, 15B, 15C, and 15D) that are attached to the annular yoke 11, a first electromagnetic actuator for driving the lens frame 2 along the optical axis Oa. In the magnets 15 (15A, 15B, 15C, and 15D), the faces that face the lens frames 2 are either north poles or south poles, and the back face sides thereof are the opposite poles, to structure a magnetic circuit from the one face sides across the first coil 13, to the back face sides. Flat yokes 12A, 12B, 12C, and 12D are disposed on the back face sides of the magnets 15 (15A, 15B, 15C, and 15D) in order to structure these magnetic circuits.

The second coils 14 (14A and 14B) are held, respectively, in two coil holding portions 3E in the base member 3, to structure it, in cooperation with the magnets 15 (15A and 15B) that are attached to the annular yoke 11, a second electromagnetic actuator for driving the lens frame 2 in directions that are perpendicular to that of the optical axis Oa. The second coils 14A and 14B are wrapped in oval shapes that have linear portions, where the second coils 14A and 14B have linear portions that extend in mutually differing directions in a plane that is perpendicular to the optical axis Oa. Given this, the magnets 15 (15A and 15B) form magnetic circuits from one pole thereof across one of the linear portions of the second coils 14 (14A or 14B), along the direction of the optical axis, and then back across the other linear portion, in the opposite direction, to return to the other pole.

The base member 3 is provided with an opening 3A that faces the lens attaching opening 2A of the lens frame 2, where the plurality of connecting terminals 8 is disposed therearound. In the example that is illustrated, the base member 3 is formed so as to be a rectangle, corresponding to the annular yoke 11, and insertion holes 3G, for supporting the wire supports 6A, 6B, 6C, and 6D are formed on the four corners thereof. Moreover, the aforementioned coil holding portion 3E, in addition to a Hall element holding portion 3F, are provided on the surface that faces the annular yoke 11, and, additionally, a contact protrusion 3H, for contacting the bottom end of the lens frame 2, is also provided. Hall elements (position detecting elements) 16, mounted on circuit boards 16A, are provided respectively at the two Hall element holding portions 3F. The two Hall elements 16 face mutually differing directions within a plane that crosses the optical axis Oa, arranged so as to face the magnets 15C and 15D that are attached to the annular yoke 11.

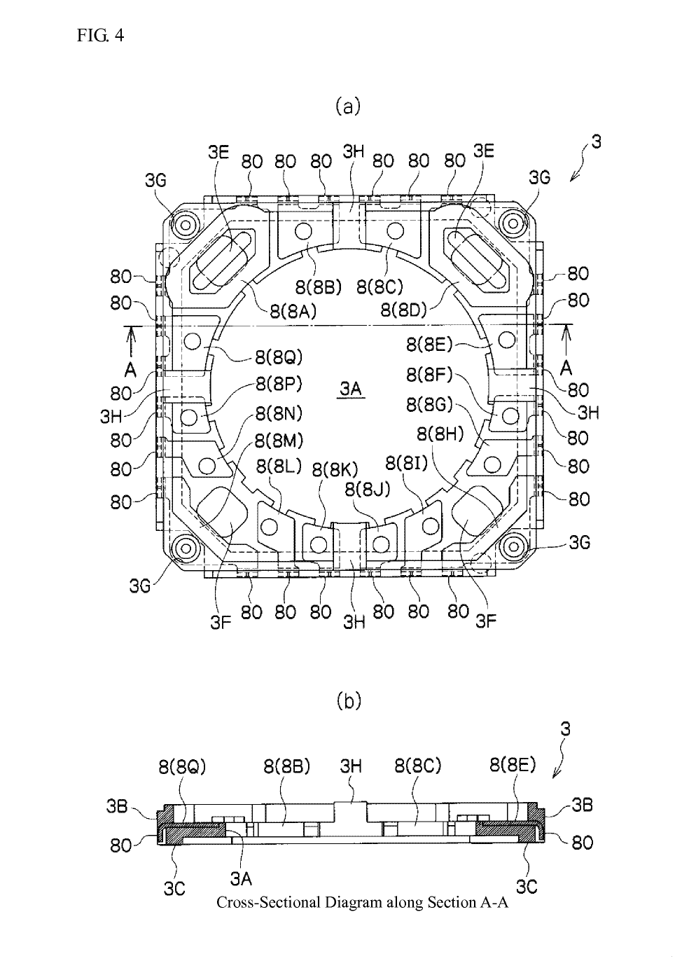

FIG. 4 is explanatory diagrams illustrating details of the base member for the driving device (wherein (a) is a plan view diagram and (b) is a cross-sectional diagram along the section A-A). The plurality of connecting terminals 8 that are arranged on the base member 3 are formed independently embedded in the base member 3 that is formed from a resin material, or the like (through insertion molding), so that portions thereof are exposed on the lens frame 2 side and other portions are exposed on the side face 3B or back face 3C of the base member 3, to structure the external connecting faces 80.

In the example that is illustrated, 16 connecting terminals 8 (8A-8Q) are arranged in the base member 3. Of these, one end and the other end of the second coil 14B are connected to the connecting terminal 8Q and the connecting terminal 8B, where one end and the other end of the second coil 14A are connected to the connecting terminal 8C and the connecting terminal 8E. Furthermore, the four terminals of one of the Hall elements 16 are connected respectively to the connecting terminals 8F, 8G, 8I, and 8J, and the four terminals of the other Hall element 16 are connected respectively to the connecting terminals 8K, 8L, 8N, and 8P. Moreover, the wire support 6A forms a power supply path E, with an end portion thereof connected to the connecting terminal 8D within the insertion hole 3G, where the wire support 6D forms a power supply path E, with an end portion thereof connected to the connecting terminal 8H within the insertion hole 3G.

The power supply paths of such a lens driving device 1 will be explained. That which is subject to the supply of power by the driving means (the electromagnetic actuator) 7 of the lens driving device 1 is the first coil 13 and the two second coils 14 (14A and 14B). One end of the first coil 13 is connected to the lens frame attaching portion 5A1 of the top leaf spring 5A, and the other end is connected to the lens frame attaching portion 5B1 of the top leaf spring 5B. For the first coil 13, the wire supports 6A and 6D, which are second elastic supporting members 6 which are the supporting portion 4, to which the output terminals for the supply power are connected to the external connecting faces 80 of the connecting terminals 8D and 8H that are provided in the base member 3, form a power supply path E, and also the top leaf springs 5A and 5B, which are first elastic supporting members 5 that are the supporting portion of 4, form a power supply path E, so that electricity is supplied through the lens frame attaching portions 5A1 and 5B1.

For the second coil 14A, electricity is supplied directly through the output terminals for the supply of power being connected to the external connecting faces 80 of the connecting terminals 8C and 8E that are provided in the base member 3. For the second coil 14B, electricity is supplied directly through the output terminals for the supply of power being connected to the external connecting faces 80 of the connecting terminals 8Q and 8B that are provided in the base member 3.

The outputs of the Hall elements 16, which carry out detection of the position of the lens frame 2 in the direction that is perpendicular to the optical axis Oa, are sent via a control circuit, not shown, that passes through the external connecting faces 80 of the connecting terminals 8F, 8G, 81, and 8J for one of the Hall elements 16, and sent via a control circuit, not shown, that passes through the external connecting faces 80 of the connecting terminals 8K, 8L, 8N, and 8P for the other of the Hall elements 16.

With such a lens driving device 1, the end portions of the plurality of different power supply paths that are subject to supply of power in the driving means 7, and the output terminals of the Hall elements 16 that are the position detecting elements for the lens frame 2 are all connected to the connecting terminals 8 that are provided in the base member 3, where the external connecting faces 80 of the connecting terminals 8 are exposed at the side face 3B or back face 3C of the base member 3. As a result, it is possible to carry out all at once the connections of the driving means 7 and of the control circuits to the Hall elements 16, which are the position detecting elements, as connections with the external connecting faces 80 in the base member 3. This makes it possible to carry out the assembly of the lens driving device 1, including connecting the control circuit, easily.

In the example that is illustrated, the connecting terminals 8A and 8M in the base member 3 are not used for electrical connections. However, if, in terms of the structure of the external output terminals for the control circuit, it would be better if the supply of power to the first coil 13 were to use the external connecting faces 80 of the connecting terminals 8A and 8M, then these may be used, leaving the connecting terminals 8D and 8H. Providing more connecting terminals 8 in the base member 3 than the actual number of terminals that will be connected electrically can increase the flexibility in connecting control circuits to the outside.

In the example that is illustrated, two external connecting faces 80 are produced for a single terminal for the connecting terminals 8A, 8B, 8C, 8D, 8E, 8H, 8M, and 8Q. Producing a plurality of external connecting faces 80 from single connecting terminals 8 and exposing them on the side face 3B and back face 3C of the base member 3 in this way can also increase the flexibility of the connections with the outside control circuits.

Moreover, in the lens driving device 1, all of the power supply paths, including the power supply paths used for the wire supports 6A and 6D (the second elastic supporting members 6) are disposed within a planar region of the base member 3. This makes it possible to reduce the space occupied through the installation of the lens driving device, when compared to the case wherein the power supply paths are provided using, for example, separate flexible substrates around the lens frame.

Note that, as illustrated in FIG. 1, the lens driving device 1 may be provided with a cover member 17 that has an electromagnetic shielding function, covering the lens frame 2, the supporting portion 4, and the driving means 7. This cover member 17 may be provided with other mechanisms, such as a shutter mechanism, along with an optical path opening 17A. The driving means for this other mechanism may be provided with power from the connecting terminals 8 of the base member 3 through, for example, the provision of an interconnection along the cover member 17.

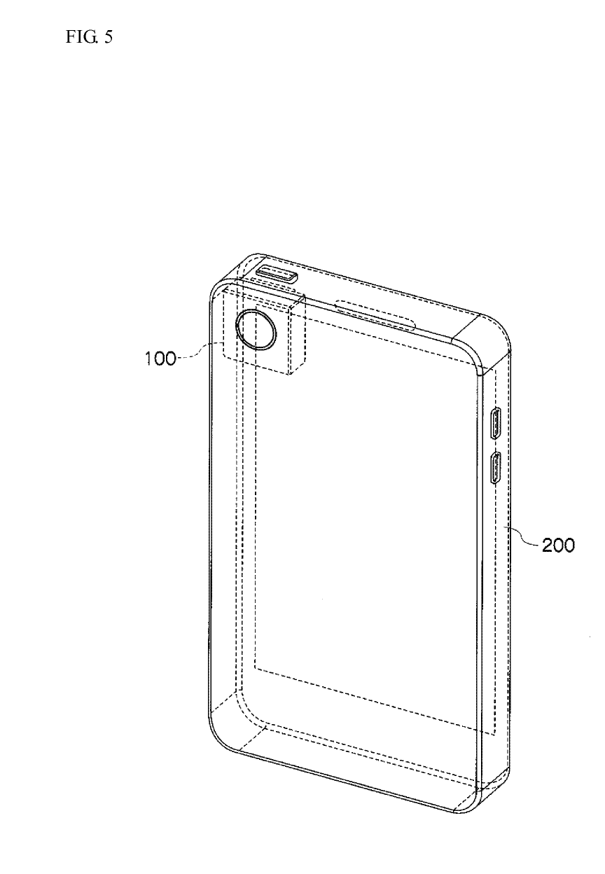

FIG. 5 illustrates an example of an electronic instrument that is provided with a lens driving device. As illustrated in FIG. 5, the lens driving device 1 is equipped in a camera module 100 or in an electronic instrument of 200 (a mobile telephone, a smart phone, a tablet PC, a notebook PC, or the like) that is provided with a camera module 100. In the camera module 1 or the electronic instrument 200 that is provided with the lens driving device 100, the lens driving device 1 can be assembled easily, enabling excellent manufacturability. Moreover, this can reduce the space occupied through the installation of the lens driving device 1, enabling miniaturization of the camera module 100 itself and of the electronic instrument 200.

While examples according to the present invention were explained in detail above referencing the drawings, the specific structure is not limited to these examples, but rather design changes, and the like, within a range that does not deviate from the spirit and intent of the present invention are also included within the present invention. Furthermore, the various examples described above may be combined together using each other's technologies insofar as there are no particular problems or contradictions with the purposes, structures, and the like, thereof.

1. A lens driving device comprising:
a lens frame;
a base member;
a supporting portion that supports the lens frame to be moveable, relative to the base member, in a direction of an optical axis and in a direction that is perpendicular to the optical axis; and
a driving unit that drives respectively the lens frame in the direction of the optical axis and in the direction perpendicular to the optical axis, wherein:
the supporting portion comprises a path for supplying power to the driving unit;
the base member comprises a plurality of connecting terminals wherein the external connecting faces thereof are exposed; and
the paths for supplying power to the driving unit are connected to the connecting terminals.

2. The lens driving device as set forth in claim 1, wherein:
the external connecting faces are exposed on the side face or back face of the base member; and
the connecting terminals are formed embedded in the base member.

3. The lens driving device as set forth in claim 1, wherein:
the driving unit comprise a first coil that drives the lens frame in the direction of the optical axis and a second coil that drives the lens frame in the direction that is perpendicular to the optical axis;
the supporting portion comprises a path for supplying power to the first coil; and
the path for supplying power, provided in the supporting portion, and the second coil are connected to connecting terminals.

4. The lens driving device as set forth in claim 3, wherein:
the supporting portion comprises:
a yoke, provided with magnets for the driving unit, surrounding around the lens frame;
a first elastic supporting member that elastically supports, along the direction of the optical axis, the lens frame relative to the yoke; and
a second elastic supporting member that supports the yoke relative to the base member elastically along a direction that is perpendicular to the optical axis, wherein:
the first elastic supporting member and the second elastic supporting member form a path for supplying power to the first coil.

5. The lens driving device as set forth in claim 1, wherein:
a position detecting element that detects a position, in the direction that is perpendicular to the optical axis, of the lens frame is disposed in the base member; and
the position detecting element is connected to a connecting terminal.

6. The lens driving device as set forth in claim 1, wherein:
the supporting portion is provided within a planar region of the base member.

7. A camera module provided with a lens driving device comprising:
a lens frame;
a base member;
a supporting portion that supports the lens frame to be movable, relative to the base member, in a direction of an optical axis and in a direction that is perpendicular to the optical axis; and
a driving unit that drives respectively the lens frame in the direction of the optical axis and in the direction perpendicular to the optical axis, wherein:
the supporting portion comprises a path for supplying power to the driving unit;
the base member comprises a plurality of connecting terminals wherein the external connecting faces thereof are exposed; and
the paths for supplying power to the driving unit are connected to the connecting terminals.

8. An electronic instrument provided with a lens driving device comprising:
a lens frame;
a base member;
a supporting portion that supports the lens frame to be movable, relative to the base member, in a direction of an optical axis and in a direction that is perpendicular to the optical axis; and
a driving unit that drives respectively the lens frame in the direction of the optical axis and in the direction perpendicular to the optical axis, wherein:
the supporting portion comprises a path for supplying power to the driving unit;
the base member comprises a plurality of connecting terminals wherein the external connecting faces thereof are exposed; and
the paths for supplying power to the driving unit are connected to the connecting terminals.
